(19) United States
(12) Patent Application Publication
(10) Pub. No.: US 2013/0024517 A1
(43) Pub. Date: Jan. 24, 2013

(54) Apparatus, system and method for interfacing social networking application and provider

(71) Applicant: Georgi Milev, Shumen (BG)

(72) Inventor: Georgi Milev, Shumen (BG)

(21) Appl. No.: 13/554,949

(22) Filed: Jul. 20, 2012

Related U.S. Application Data
(60) Provisional application No. 61/510,270, filed on Jul. 21, 2011.

(51) Int. Cl. G06F 15/16

(52) U.S. Cl. 709/204

(57) ABSTRACT

An apparatus, system and method for interfacing social networking application and provider is disclosed. The present invention provides capabilities for social networking, implemented by one or more subsystems. Subsystems exist for generating inferred social value metrics; collecting participants' input for the purposes of interacting with the present apparatus and respectively with other participants; data storage and layout; presentation and display of the quantities described hereinabove to a person or a computer system.

### CROSS-REFERENCE TO RELATED APPLICATIONS

This application claims priority from U.S. provisional patent application No. 61/510,270 filed Jul. 21, 2011

### FIELD OF THE INVENTION

This invention relates to techniques for enabling a social networking application to provide a user thereof with a way to access the most famous and potentially the most socially compatible and socially valuable eventual interlocutors for the not necessarily single purpose of filtering out quality content postings thereof from noise.

### BACKGROUND OF THE INVENTION

Due to their inherent nature, people need to communicate with each other, be it for personal and leisure purposes, e.g. finding a compatible mate, friend, colleague; be it for commercial purposes, whereby for example a corporation wishes to advertise itself to its potentital stakeholders.

With the advent of the world wide web, social networking websites have arisen into prominence—dating sites, classmate databases, forum communities etc. However those introduce problems such as when a dating site is being browsed for potential mates, or a forum community—for quality content postings, much of the results are being noise, which is sought to be eliminated.

A plurality of social networking websites have attempted to solve problems, in the most cases have failed and likewise have introduced problems of their own. In addition, the problem of finding the most famous and agreed-upon mate is difficult to solve and thus need arises for a central provider, an operator of the present invention, to solve that problem for them—for economic reasons.

No prior art of this scope is known as of this moment.

### SUMMARY

The present invention provides for a social networking service a way for it to submit subject relationship data to an external provider of the present invention; to collect subjects' respective degrees of famousness, social value and agreed-upon-ness for the purpose of storing them and/or displaying them to the subject itself.

The extent to which a person is famous in a network may be displayed in numerical fashion, normalized or not.

Additional aspects, applications and advantages are provided by the following description and associated figures.

### BRIEF DESCRIPTION OF THE DRAWINGS

FIG. 1 describes the core subject and inter-subject data structures

### DETAILED DESCRIPTION OF THE INVENTION

Anyone with ordinary skills in computer programming and database administration should comprehend this document.

The term “database” in will herein mean an abstract computer storage system, comprising one or more physical servers (or a server farm) provisioned with appropriate software packages, such as relational database management systems, nosql database systems, or whatever necessary means for storing data.

“Entity” will herein mean a record in a relational database or its equivalent in non-relational or any kind of databases; with or without any of its related entities. Every definition, having a Long id field, is an entity definition, unless having a composite key. The reverse is also true.

“Persist” will herein mean storing an entity into a database, via execution of the respective subroutine of that database.

“Remove” will herein mean removing an entity from a database, via execution of the respective subroutine of that database.

An “application” or “community” will herein mean any community software package (or a particular deployment instance thereof), client or server, related to and developed in compliance with this apparatus' standard application programming interface.

“Standard channel” means either of TCP/IP, OSI, RESTful or nonRESTful telecommunication channel, or any other networking standard.

A social networking application (a community) uses this invention by means of a provider and its respective application programming interface.

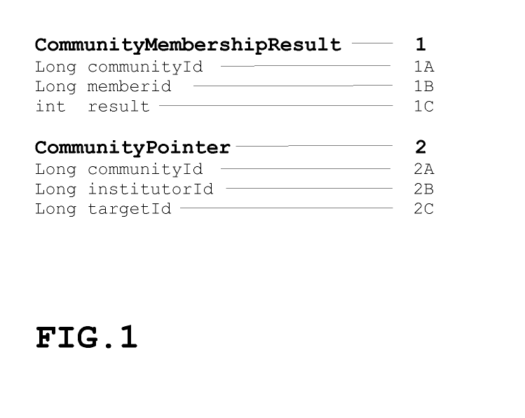

FIG. 1 describes the core subject entities. Each subject is a anyone or anything using the apparatus by means of graphical user interface, or application programming interface. Each subject may be using the apparatus via the respective community GUI, or another native interface type. Each subject may have different results generated by this apparatus in different context communities.

The following description relates to the data storage and layout subsystem.

For each subject in the context of a community, there is a single CommunityMembershipResult 1.

It has a communityId 1A, memberId 1B, result 1C.

For each vector of subjects, in the context of a community, there is a single or none CommunityPointer 2.

It has a communityId 2A, institutorId 2B, targetId 2C.

A directed CommunityPointer 2 can be instituted by one subject to another, via a toggle control on the latter's profile on the social networking application's GUI.

A CommunityPointer 2 designates the binary willingness of the institutor to socially support the CommunityPointer target with id 2C, pertaining to a particular community—e.g. one can support another as a dentist, but may wish not to—as a carpenter.

For each subject, based on the CommunityPointer 2 graph, an eigenvector centrality measure is calculated iteratively and indefinitely until when sorted by centrality, the subjects reach monotonically increasing centrality measures at maximum of the points. Then the whole sorted set of subjects by the centrality measure is considered in a descending manner. Then for each subject, a normalized social score S can be displayed after being calculated as follows and is persisted in the database, in the form of a CommunityMembershipResult 1:
c=total subjects count in this community
i=the zero-based array index of the subject in the sorted set of descending centrality measures

S=ceil[(1−i/c)*100]

The method of interfacing is hereinbelow described:

The entire interfacing telecommunication is done via a standard channel.

Any submit is followed by a persist.
This method may have multiple embodiments and its function is independent of its implementation, which can be in hardware, software, or other means.

Upon the application and provider integration, the former submits the prior asymmetric social relationship data, and thus prepopulates the CommunityPointer 2 set with respect to the given community (application). This step is done once for each community.

Then the application becomes in ‘online’ state—available for public access.

From now on, the application, on behalf of its users, on a current basis, submits or removes CommunityPointer 2 data.

Also, on a current basis, the provider considers the set of CommunityPointer 2 data, pertaining to the community instance, after creating an empty logical graph.

For each datum, the graph's vertices set is checked for containment of each of the datum's institutor ids 2B and target ids 2C. If negative then a graph vertex is created with that id. Finally the datum is added to the graph as an edge.

Then, the S metric is calculated and persisted in the CommunityMembershipResult 1 entity for each of the graph's vertices—in the result field 1C.

Also, on a current basis, the application retrieves the CommunityMembershipResult 1, by key of 1A and 1B combined, via single or bulk requests—depending on the usage context, and then eventually retransmits the result 1C to the respective community member/user.

This invention does not necessarily relate to the S metric and does not require the result field 1C to contain instances of necessarily the S metric. Any other graph-based centrality and/or other kind of metric can be transmitted to an application via this interface, subject of the current document.

In addition, data layout described hereinabove is mentioned as an example embodiment, an for illustration of the functionality of the present invention, but there may exist embodiments that implement a functionality that still fulfills the requirements of usefulness and the purpose of the present invention.

What is claimed is:

1. A computer implemented system for facilitating selective consumption of social networking participants' data output among each other, each of said social networking participants having a social rating metric, said system comprising a database and an application programming interface, said system further implementing capabilities of serving a plurality of communities, with a user being capable of joining one or more of said communities, said user having a distinct social rating metric for each community.

2. A system of claim 1, further comprising a method of gathering social networking participants' interconnection graph, analysis thereof and transmitting a consequent social quality score, with its preferred embodiment being an eigenvector centrality.

3. An apparatus for social networking, implementing the system of claim 1, said apparatus comprising software, its respective execution environment with the necessary memory and processing units, a networking interface, routing infrastructure, input and output devices.

4. A system of claim 1, further comprising a method of gathering input social connections data, storing it in an appropriate form, determining a social quality metric upon it in an environment of active subject communication, and displaying said metric directly or using it as a means for further noise removal.

5. An apparatus of claim 1, having a standard or RESTful web service API.

6. A system of claim 2, further comprising a computer network enabled community, implementing an application programming interface compliant to the present invention.
